(19) United States
(12) Patent Application Publication
(10) Pub. No.: US 2021/0255289 A1
(43) Pub. Date: Aug. 19, 2021

(54) LIGHT DETECTION METHOD, LIGHT DETECTION DEVICE, AND MOBILE PLATFORM

(71) Applicant: SZ DJI TECHNOLOGY CO., LTD., Shenzhen (CN)

(72) Inventors: Tao LI, Shenzhen (CN); Xiaoping HONG, Shenzhen (CN); Han CHEN, Shenzhen (CN)

(21) Appl. No.: 17/246,346

(22) Filed: Apr. 30, 2021

Related U.S. Application Data
(63) Continuation of application No. PCT/CN2018/113131, filed on Oct. 31, 2018.

(51) Int. Cl. G01S 7/487; G01S 17/89; G06N 20/00

(52) U.S. Cl. CPC G01S 7/4876; G06N 20/00; G01S 17/89

(57) ABSTRACT

Embodiments of the present disclosure provides a light detection method, a light detection device, and a mobile platform with improved accuracy of light detection. The method includes obtaining the environment parameter for performing light detection; determining a working mode for performing light detection based on the obtained environment parameter, different working modes corresponding to different working parameters; and performing light detection based on the determined working mode. The light detection is configured to calculate a distance between a light detection device and a reflector based on a transmitted pulse sequence and a reflected pulse sequence reflected by the reflector.

### CROSS-REFERENCE TO RELATED APPLICATION

This application is a continuation of International Application No. PCT/CN2018/113131, filed Oct. 31, 2018, the entire content of which is incorporated herein by reference.

### TECHNICAL FIELD

The present disclosure relates to the field of detection and, more specifically, to a light detection method, a light detection device, and a mobile platform.

### BACKGROUND

Light detection devices (e.g., laser detectors) can emit a pulse sequence and can receive a pulse sequence reflected by a reflector. After receiving the reflected pulse sequence, the pulse sequence can be converted into an electrical signal, and information such as the distance between the reflector and the light detection device can be obtained based on the electrical signal.

In an abnormal environment, the reflected pulse sequence may not be a reflection from a normal object (an object expected to be detected), but a reflection caused by an object (e.g., a particle object) in the abnormal environment, which affects the accuracy of light detection.

Therefore, the accuracy of light detection in an abnormal environment needs to be improved.

### SUMMARY

Embodiments of the present disclosure provide a light detection method, a light detection device, and a mobile platform, providing improved accuracy of light detection.

In one aspect, a light detection method is provided including: obtaining an environment parameter for performing light detection; determining working parameters for performing light detection based on the environment parameter; and performing light detection based on the determined working parameters. The light detection is configured to calculate a distance between a light detection device and a reflector based on a transmitted pulse sequence and a pulse sequence reflected by the reflector.

In another aspect, a light detection method is provided including: obtaining an environment parameter for performing light detection; determining a working mode for performing light detection based on the obtained environment parameter, different working modes corresponding to different working parameters; and performing light detection based on the determined working mode. The light detection is configured to calculate a distance between a light detection device and a reflector based on a transmitted pulse sequence and a reflected pulse sequence reflected by the reflector.

In another aspect, a light detection method is provided including: transmitting a light pulse sequence; performing photoelectric conversion on the pulse sequence to obtain an electrical signal; sampling the electrical signal to obtain a sampled waveform; inputting the sampled waveform into a filtering model to obtain an output result, the output result indicating whether to filter the sampled waveform or a probability of needing filtering; and processing the waveform based on the output result.

In another aspect, a light detection device is provided including: an acquisition module configured to acquire an environment parameter for performing light detection; a determination module configured to determine working parameters for performing light detection based on the environment parameter acquired by the acquisition module; and a light detection module configured to perform light detection based on the working parameter determined by the determination module. The light detection is configured to calculate a distance between the light detection and a reflector based on a transmitted pulse sequence and a pulse sequence reflected by the reflector.

In another aspect, a light detection device is provided including: an acquisition module configured to acquire an environment parameter for performing light detection; a determination module configured to determine a working mode for performing light detection based on the environment parameter acquired by the acquisition module, different working modes corresponding to different working parameters; and a light detection module configured to perform light detection based on the working mode determined by the determination module. The light detection is configured to calculate a distance between the light detection and a reflector based on a transmitted pulse sequence and a reflected pulse sequence reflected by the reflector.

In another aspect, a light detection device is provided including: a transmitting module configured to transmit a light pulse sequence; a photoelectric conversion module configured to perform photoelectric conversion on the pulse sequence to obtain an electrical signal; a sampling module configured to sample the electrical signal to obtain a sampled waveform; a filtering module configured to input the sampled waveform into a filtering model to obtain an output result, the output result indicating whether to filter the sampled waveform or a probability of needing filtering; and a processing module configured to process the waveform based on the output result.

In another aspect, a mobile platform is provided including the disclosed light detection devices.

Since the environment may affect the accuracy of light detection, the embodiments of the present disclosure can obtain the environment parameter during light detection, and based on the environment parameter, determine the working parameters or working mode used for light detection for light detection. Therefore, when performing light detection, the embodiments of the present disclosure consider the impact of the environment, which can avoid the issue of low measurement accuracy caused by the environment on the light detection, and is especially suitable for light detection in an abnormal environment.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a schematic diagram of a light detection device according to an embodiment of the present disclosure.

FIG. 2 is a schematic diagram of another light detection device according to an embodiment of the present disclosure.

FIG. 3 is a schematic diagram a light detection method according to an embodiment of the present disclosure.

FIG. 4 is a schematic diagram another light detection method according to an embodiment of the present disclosure.

FIG. 5 is a schematic diagram another light detection method according to an embodiment of the present disclosure.

FIG. 6 is a schematic diagram another light detection method according to an embodiment of the present disclosure.

FIG. 7 is a schematic diagram another light detection device according to an embodiment of the present disclosure.

FIG. 8 is a schematic diagram another light detection device according to an embodiment of the present disclosure.

FIG. 9 is a schematic diagram another light detection device according to an embodiment of the present disclosure.

FIG. 10 is a schematic diagram of a mobile platform according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Unless otherwise specified, all the technical and scientific terms used in the embodiments of the present disclosure refer to the same meaning commonly understood by those skilled in the art. The terminologies used in the present disclosure are intended to describe specific embodiments, and not to limit the scope of the present disclosure.

The technical solution provided by the various embodiments of the present disclosure can be applied to a light detection device, and the light detection device may be an electronic device such as a laser radar and a laser ranging device. In one embodiment, the light detection device may be configured to sense external environmental information, such as distance information, orientation information, reflection intensity information, speed information, and reflection angle information of targets in the environment. In one implementation, the light detection device may detect the distance between the light detection device and an object to be detected by measuring a time of light propagation between the light detection device and the object to be detected, that is, the time-of-flight (TOF). Alternatively, the light detection device may also use other technologies to detect the distance from the object to be detected to the light detection device, such as a ranging method based on phase shift measurement or a ranging method based on frequency shift measurement, which is not limited here.

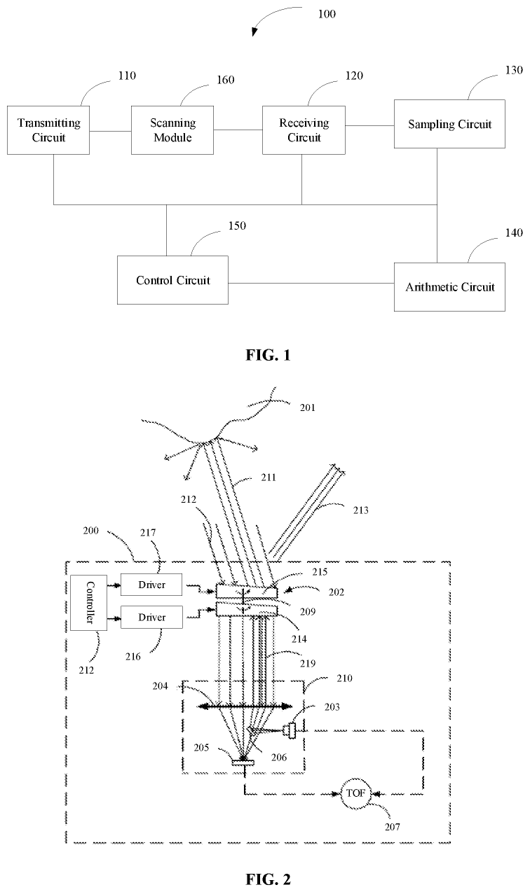

For the ease of understanding, the workflow of light detection will be described below with reference to a light detection device 100 shown in FIG. 1 as an example.

As shown in FIG. 1, the light detection device 100 may include a transmitting circuit 110, a receiving circuit 120, a sampling circuit 130, and an arithmetic circuit 140.

The transmitting circuit 110 may emit a light pulse sequence (e.g., a laser pulse sequence). The receiving circuit 120 can receive the light pulse sequence reflected by the object to be detected, and perform photoelectric conversion on the light pulse sequence to obtain an electrical signal, and then the electrical signal can be processed and output to the sampling circuit 130. The sampling circuit 130 can sample the electrical signal to obtain a sampling result. The arithmetic circuit 140 may determine the distance between the light detection device 100 and the object to be detected based on the sampling result of the sampling circuit 130.

In some embodiments, the light detection device 100 may further include a control circuit 150. The control circuit 150 can control other circuit, for example, control the working time of each circuit and/or set parameters for each circuit, etc. In another example, the control circuit 150 may realize the acquisition of an environment parameter, the determination of the working parameter or the working mode, or the training of filter models in the light detection method of the embodiments of the present disclosure.

It should be understood that although the light detection device shown in FIG. 1 includes a transmitting circuit, a receiving circuit, a sampling circuit, and an arithmetic circuit to emit a light beam for detection, however, the embodiments of the present disclosure are not limited thereto. The number of any one of the transmitting circuit, the receiving circuit, the sampling circuit, and the arithmetic circuit may also be at least two, which can be configured to emit at least two light beams in the same direction or different directions. In some embodiments, the at least two light beams may be emitted at the same time or at different times. In one example, the light source emitter in the at least two emitting circuits may be packaged in the same module. For example, each transmitting circuit may include a laser transmitter, and the dies in the laser transmitters in the at least two transmitting circuits may be packaged together and housed in the same packaging shell.

In some implementations, in addition to the circuit shown in FIG. 1, the light detection device 100 may further include a scanning module 160 for changing the propagation direction of the light pulse sequence emitted by the transmitting circuit and emit it.

In some embodiments, a module including the transmitting circuit 110, the receiving circuit 120, the sampling circuit 130, and the arithmetic circuit 140 may be referred to as a light detection module. The light detection module may be independent of other modules, such as the scanning module 160.

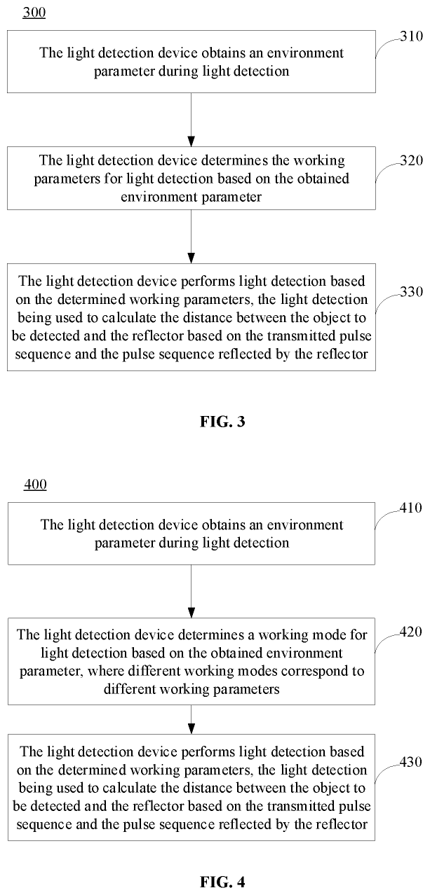

In order to make the working principle of the light detection device of the present disclosure more clearly, the light detection device of the embodiments of the present disclosure will be described below with reference to FIG. 2.

A coaxial light path may be used in the light detection device, that is, the light beam emitted by the light detection device and the reflected light beam can share at least a part of the light path in the light detection device. Alternatively, the light detection device may also adopt an off-axis light path, that is, the light beam emitted by the light detection device and the reflected light beam may be respectively transmitted along different light paths in the light detection device. FIG. 2 is a schematic diagram of a light detection device using a coaxial light path according to an embodiment of the present disclosure.

A light detection device 200 includes a light transceiver device. The light transceiver device includes a light source 203 (including the transmitting circuit described above), a collimating element 204, a detector 205 (which may include the receiving circuit, sampling circuit, and arithmetic circuit described above), and a light path changing element 206. The transceiver device may be configured to transmit the light beam, received the returned light, and convert the returned light into an electrical signal. The light source 203 may be configured to emit a light beam. In one embodiment, the light source 203 may be configured to emit a laser beam. In some embodiments, the laser beam emitted by the light source 203 may be a narrow-bandwidth light beam. The collimating element 204 may be disposed on an exit light path of the light source and configured to collimate the light beam emitted from the light source 203 and collimate the light beam emitted from the light source 203 into parallel light. The collimating element 204 may also be configured to condense at least a part of the returned light reflected by the object to be detected. The collimating element 204 may be a collimating lens or other elements capable of collimating light beams.

In the embodiment shown in FIG. 2, by using the light path changing element 206 to combine the transmitting light path and the receiving light path in the light detection device before the collimating element 204, the transmitting light path and the receiving light path can share the same collimating element, making the light path more compact. In some other implementations, the light source 203 and the detector 205 may also use their respective collimating elements, and the light path changing element 206 may be disposed behind the collimating element.

In the embodiment shown in FIG. 2, since the light beam divergence angle of the light beam emitted by the light source may be relatively small, and the light beam divergence angle of the returned light received by the detector may be relatively large, the light path changing element may use a small-area mirror to combine the emitting light path and the receiving light path. In some other implementations, the light path changing element may also adopt a reflector with a through hole, where the through hole may be configured to transmit the emitted light of the light source 203, and the reflector may be configured to reflect the returned light to the detector 205. In this way, it is possible to reduce the blocking of the returned light by the support of the small reflector when the small reflector is used.

In the embodiment shown in FIG. 2, the light path changing element may deviate from the optical axis of the collimating element 204. In some other implementations, the light path changing element may also be positioned on the optical axis of the collimating element 204.

The light detection device 200 may further include a scanning module 202. The scanning module 202 may be disposed on the exit light path of the light transceiver device. The scanning module 202 may be configured to change the transmission direction of a collimated light beam 219 emitted by the collimating element 204, and project the returned light to the collimating element 204. The returned light may be collected on the detector 205 via the collimating element 204.

In one embodiment, the scanning module 202 may include one or more optical element, such as a lens, a mirror, a prism, a grating, an optical phased array, or any combination of the foregoing optical elements. In some embodiments, a plurality of optical elements of the scanning module 202 may rotate around a common axis 209, and each rotating optical element may be configured to continuously change the propagation direction of the incident light beam. In one embodiment, the plurality of optical elements of the scanning module 202 may rotate at different rotation speeds. In another embodiment, the plurality of optical elements of the scanning module 202 may rotate at substantially the same rotation speed.

In some embodiments, the plurality of optical elements of the scanning module 202 may also be rotated around different axes. In some embodiments, the plurality of optical elements of the scanning module 202 may also rotate in the same direction or in different directions, or vibrate in the same direction, or vibrate in different directions, which is not limited herein.

In one embodiment, the scanning module 202 may include a first optical element 214 and a driver 216 connected to the first optical element 214. The driver 216 may be configured to drive the first optical element 214 to rotate around the rotation axis 209, such that the first optical element 214 can change the direction of the collimated light beam 219. The first optical element 214 may project the collimated light beam 219 to different directions. In one embodiment, an angle between the direction of the collimated light beam 219 changed by the first optical element and the rotation axis 209 may change with the rotation of the first optical element 214. In one embodiment, the first optical element 214 may include a pair of opposite non-parallel surfaces, and the collimated light beam 219 may pass through the pair of surfaces. In one embodiment, the first optical element 214 may include a prism whose thickness may vary in at least one radial direction. In one embodiment, the first optical element 214 may include a wedge-angle prism to refract the collimated light beam 219. In one embodiment, the first optical element 214 may be coated with an anti-reflective coating, and the thickness of the anti-reflective coating may be equal to the wavelength of the light beam emitted by the light source 203, which can increase the intensity of the transmitted light beam.

In one embodiment, the scanning module 202 may further include a second optical element 215. The second optical element 215 may rotate around the rotation axis 209, and the rotation speed of the second optical element 215 may be different from the rotation speed of the first optical element 214. The second optical element 215 may be configured to change the direction of the light beam projected by the first optical element 214. In one embodiment, the second optical element 215 may be connected to another driver 217, and the driver 217 may drive the second optical element 215 to rotate. The first optical element 214 and the second optical element 215 may be driven by different drivers, such that the rotation speeds of the first optical element 214 and the second optical element 215 may be different, such that the collimated light beam 219 may be projected to different directions in the external space to scan a larger spatial range. In one embodiment, a controller 218 may control the driver 216 and driver 217 to drive the first optical element 214 and the second optical element 215, respectively. The rotation speeds of the first optical element 214 and the second optical element 215 may be determined based on the area and pattern expected to be scanned in actual applications. The drivers 216 and 217 may include motors or other driving devices.

In some embodiments, the second optical element 215 may include a pair of opposite non-parallel surfaces, and a light beam may pass through the pair of surfaces. In one embodiment, the second optical element 215 may include a prism whose thickness may vary in at least one radial direction. In one embodiment, the second optical element 215 may include a wedge-prism. In one embodiment, the second optical element 215 may be coated with an anti-reflective coating to increase the intensity of the transmitted light beam.

The rotation of the scanning module 202 may project light to different directions, such as directions 212 and 213, such that the space around the light detection device 200 (e.g., including a distance measuring device) can be scanned. When the light at direction 213 projected by the scanning module 202 hits an object 201 to be detected, a part of the light may be reflected by the object 201 to be detected to the light detection device 200 in a direction opposite to the projected light at direction 213. The scanning module 202 may receive the returned light at direction 212 reflected by the object 201 to be detected and project the returned light at direction 212 to the collimating element 204.

The collimating element 204 may condense at least a part of the returned light 212 reflected by the object to be detected 202. In one embodiment, the collimating element 204 may be coated with an anti-reflective coating to increase the intensity of the transmitted light beam. The detector 205 and the light source 203 may be disposed on the same side of the collimating element 204, and the detector 205 may be configured to convert at least a part of the returned light passing through the collimating element 204 into electrical signals.

In one embodiment, the light source 203 may include a laser diode through which nanosecond laser light may be emitted. For example, the laser pulse emitted by the light source 203 may last for 10 ns. Further, the laser pulse receiving time may be determined, for example, by detecting the rising edge time and/or the falling edge time of the electrical signal pulse to determine the laser pulse receiving time. In this way, the light detection device 200 may calculate the TOF at 207 using the laser pulse receiving time information and the pulse sending time information, thereby determining the distance between the object to be detected 202 and the light detection device 200.

The distance and orientation detected by the light detection device 200 may be used for remote sensing, obstacle avoidance, surveying and mapping, navigation, and the like.

In one embodiment, the light detection device of the embodiments of the present disclosure can be applied to a mobile platform, and the light detection device can be mounted on the platform body of the mobile platform. The mobile platform including the light detection device can measure the external environment, such as measuring the distance between the mobile platform and obstacles for obstacle avoidance and other purposes, and for two-dimensional or three-dimensional mapping of the external environment. In some embodiments, the mobile platform may include at least one or an unmanned aerial vehicle, a car, a remotely-controlled car, a robot, and a camera. When the light detection device is applied to an unmanned aerial vehicle, the platform body may be the body of the unmanned aerial vehicle. When the light detection device is applied to a car, the platform body may be the body of the car. The car may be a self-driving vehicle or a semi-self-driving vehicle, which is not limited here. When the light detection device is applied to a remotely-controlled car, the platform body may be the body of the remotely-controlled car. When the light detection device is applied to a robot, the platform body may be the robot. When the light detection device is applied to a camera, the platform body may be the camera itself

Based on the above description, the pulse sequence emitted by the light detection device can be reflected by an object, and then received by the light detection device. The light detection device can photoelectrically convert the received pulse sequence to obtain an electrical signal, and thus obtain information such as the distance between the object and the light detection device based on the electrical signal. The object reflecting the pulse sequence can be the object that is expected to be detected (which can be referred to as the normal object in the present disclosure). However, in some special environmental conditions, the object reflecting the pulse sequence may not be the object to be detected. For example, on a rainy day, the object reflected the pulse sequence may be raindrops. In this case, the distance and other information objected will be inaccurate, which will cause the issue of low accuracy of light detection.

Therefore, the embodiments of the present disclosure provide the following technical solutions, which can improve the accuracy of light detection.

It should be understood that the light detection device used in the following light detection method may be, but is not limited to, the light detection device described above.

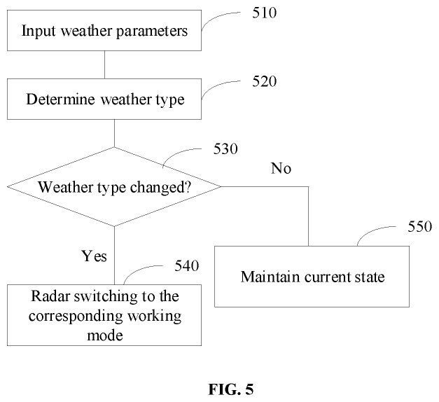

FIG. 3 is a schematic flowchart of a light detection method 300 according to an embodiment of the present disclosure. The method 300 includes at least a part of the following content.

In 310, the light detection device obtains an environment parameter during light detection.

In 320, the light detection device determines a working parameter for light detection based on the obtained environment parameter.

In 330, the light detection device performs light detection based on the determined working parameter, where the light detection is configured to calculate the distance between the light detection device and the reflector based on the transmitted pulse sequence and the pulse sequence reflected by the reflector.

More specifically, since the environment may affect the accuracy of light detection, the embodiments of the present disclosure may obtain the environment parameter during light detection, and based on the environment parameter, determine the working parameter for light detection for light detection. Therefore, when performing light detection, the embodiments of the present disclosure consider the impact of the environment, which can avoid the issue of low measurement accuracy caused by the environment on the light detection, and is especially suitable for light detection in an abnormal environment.

FIG. 4 is a schematic flowchart of a light detection method 400 according to an embodiment of the present disclosure. The method 400 includes at least a part of the following content.

In 410, the light detection device obtains the environment parameter during light detection.

In 420, the light detection device determines a working mode for light detection based on the obtained environment parameter, where different working modes correspond to different working parameters.

In 430, the light detection device performs light detection based on the determined working mode, where the light detection is configured to calculate the distance between the light detection device and the reflector based on the transmitted pulse sequence and the pulse sequence reflected by the reflector.

More specifically, since the environment may affect the accuracy of light detection, the embodiments of the present disclosure may obtain the environment parameter during light detection, and based on the environment parameter, determine the working mode for light detection for light detection. Therefore, when performing light detection, the embodiments of the present disclosure consider the impact of the environment, which can avoid the issue of low measurement accuracy caused by the environment on the light detection, and is especially suitable for light detection in an abnormal environment.

It should be understood that the method shown in FIG. 4 may be a specific implementation in the embodiments of the present disclosure, and the embodiments of the present disclosure may also have other implementations. For example, the working mode of the light detection device for light detection may include multiple working modes, and a user can select working mode from the multiple working modes (e.g., the user may select a working mode based on the environment parameter) for the current light detection. In some embodiments, the user mentioned here may be a person, or may refer to other devices other than the light detection device, for example, it may be a control system on a car, etc. The light detection device may determine the working mode for light detection based on the user's selection.

In order to fully understand the present disclosure, the specific implementations of the present disclosure will be described in detail below. It should be understood that the following description can be applied to the method 300 and also to the method 400.

The environment parameter mentioned in the embodiments of the present disclosure may include any environment parameters having an impact on light detection. In some embodiments, the environment parameter may include an environment type and/or a degree characterization range under a specific environment type.

For example, since light detection uses the transmitted pulse sequence and the received pulse sequence to determine the distance between the light detection device and the reflector, some environments may include objects that are not normally expected to be detected (e.g., particle objects in the air), and these objects may be used as reflectors to reflect the pulse sequence. Therefore, the environment parameter in the embodiments of the present disclosure may include such a parameter, and the parameter may characterize whether or not the reflector that is abnormally expected to be measured exist, or the degree of amount of existence.

Based on this, the environment parameter in the embodiments of the present disclosure may include a weather parameter, and the weather parameter may include weather types and/or degree characterization intervals under specific weather types.

For example, the weather type may be sunny, rain, snow, fog, haze, hail, or sandstorm.

In some embodiments, various weather types may be distinguished based on various degrees, for example, rain may be divided into heavy rain, moderate rain, or light rain. Each degree of weather type may correspond to a range of values. For example, for rainy days, rainfall may be divided into multiple numerical intervals. In some embodiments, the working modes or working parameters for light detection corresponding to the same numerical range may be the same. In one example, different degrees in the same weather type may correspond to the same light detection working mode or working parameter. In one example, different degrees in the same weather type may correspond to different light detection working modes or working parameters.

It should be understood that the above classification of weather types is merely a specific implementation of the embodiments of the present disclosure, and should not particularly limit the embodiments of the present disclosure.

For example, the weather types may be divided into a normal weather type and a special weather type (also referred to as abnormal weather types). In some embodiments, the normal weather type in the embodiments of the present disclosure may be understood as the type of weather that does not include abnormally expected reflectors, or the impact of the abnormally expected reflectors on light detector is negligible or relatively low. The special weather type may be understood as including abnormally expected reflectors, or the abnormally expected reflectors that have a relative high impact on the accuracy of light detection.

Of course, the special weather type may also be further subdivided into multiple types, such as the rain, snow, fog, haze, hail, or sandstorm mentioned above.

As mentioned above, the environment may include abnormal reflectors. In some cases, the environment parameter may include light parameters. For example, the light parameters may represent day or night when light is detected, or include an intensity value of light, such as the intensity value of ambient light.

Optionally, in the embodiments of the present disclosure, the environment parameter may also be characterized by the intensity and/or size of the particle object size. Different working modes and/or working parameters may correspond to different density intervals and/or size intervals of the granularity.

Optionally, in the embodiments of the present disclosure, different environment types and/or different degrees of characterization intervals may correspond to different working modes. Alternatively, it can be understood that the difference in working parameters may correspond to different environment types and/or different degrees characterization intervals.

For example, the weather type may be divided into sunny, rain, snow, fog, haze, hail, or sandstorm, and the corresponding working modes or working parameters of these types of environment may be different. For example, for the weather type of rain, it may be divided into three numerical intervals based on rainfall amount, that is, corresponding to heavy rain, moderate rain, and light rain. The three numerical intervals may correspond to the different working modes or working parameters.

Optionally, in the embodiments of the present disclosure, a part of the environment types and/or a part of the degrees of characterization intervals may correspond to the same working mode. Alternative, it can be understood that a part of the environment types and/or a part of the degrees of characterization intervals may correspond to the same working parameters.

For example, the weather type may be divided into sunny, rain, snow, fog, haze, hail, or sandstorm, and several environment types may correspond to the same working mode or working parameters. For example, the corresponding working modes or working parameters may be the same for the two environment types of rain and snow.

Optionally, in the embodiments of the present disclosure, the light detection device obtaining the environment parameter during light detection may include obtaining the current environment parameter, and using the current environment parameter as the environment parameter for light detection. At this time, the time between obtaining the environment parameter and the time between light detection may be less than a certain length of time. That is, the time interval between the time of obtaining the environment parameter and the time of light detection may be relatively short, and the change of the environment parameter can be ignored.

Alternatively, the light detection device may obtain the current environment parameter, and estimate the environment parameter for light detection based on the current environment parameter. For example, based on the change trend of the environment, the environment parameter for light detection may be estimated.

Optionally, in the embodiments of the present disclosure, the light detection device itself may have the ability to calculate the environment parameter.

For example, assume that the light detection device is mounted on a car, then information such as the frequency of the windshield wipers may be obtained, and weather parameters (e.g., rainfall amount) may be determined based on the frequency, such that light detection may be performed based on the weather parameters.

It should be understood that the light detection device may also directly use the frequency of the windshield wipers as an environment parameter characterizing the environment, and may directly perform light detection based on the frequency of the windshield wipers. In some embodiments, the frequency of the windshield wipers may be transmitted by the windshield wipers or the control for controlling the windshield wipers to the light detection device through a communication link.

In another example, the light detection device may determine the environment parameter from its own signal.

Optionally, in the embodiments of the present disclosure, the light detection device may also be a communication link to obtain environment parameter from external devices. In some embodiments, the environment parameter provided by the external device may be the current environment parameter or an estimated environment parameter during light detection.

For example, the light detection device may obtain weather forecast information transmitted by an external server through a network, or the light detection device may obtain the weather forecast information through a smart device that can read weather information. The light detection device can perform light detection based on the weather forecast information.

In another example, assume that the light detection device is mounted on a car, then the rainfall amount may be obtained based on an on-board rain gauge. Therefore, it is possible to directly determine whether it is heavy rain, moderate rain, or light rain based on the rainfall amount, and perform light detection based on this. Alternatively, it is also possible to perform light detection directly based on the rainfall amount without determining whether it is heavy rain, moderate rain, or light rain.

Optionally, in the embodiments of the present disclosure, the light detection device may have multiple working modes, and from the multiple working modes, the current working mode for light detection may be determined based on the environment parameter.

In some embodiments, the working parameters corresponding to different working modes may be different.

In the embodiments of the present disclosure, the working mode corresponding to the special weather type may be referred to as the special weather working mode. The special weather working mode may include at least two working modes, which may be optionally configured to correspond to at least two weather types or at least two intervals of degrees characterization of the same weather type.

In some implementations, the environment parameter may include the current ambient light intensity, and the light detection device may decide to enter different working modes based on different ambient light intensity. For example, the light detection device may include at least one of the following three modes, a strong light mode, a normal light mode, or a dark light mode. In the strong light mode, the noise caused by the ambient light may be relatively large. When the detector in the light detection module samples the electrical signal converted from the received optical signal, the minimum sampling threshold of at least one sampling threshold may be set higher than the minimum sampling threshold in other modes. In the dark light mode, the noise caused by the ambient light may be relatively small. When the detector in the light detection module samples the electrical signal converted from the received optical signal, the minimum sampling threshold of at least one sampling threshold may be set lower than the minimum sampling threshold in other modes.

There are multiple ways to select the trigger conditions for entering different modes. In one example, when detecting that the current ambient light intensity is less than a first predetermined value, the light detection device may choose to enter the dark light mode. In one example, when detecting that the current ambient light intensity is continuously lower than the first predetermined value for a first period of time, the light detection device may choose to enter the dark light mode. In one example, based on the current local time, the light detection device may determine to enter the dark light mode. For example, after determining that the current local time is after seven o'clock in the evening, the light detection device may choose to enter the dark light mode. In some embodiments, the time threshold for determining to enter the dark light mode may be automatically adjusted based on the current city and season of the light detection device.

In one example, when detecting that the current ambient light intensity is greater than a second predetermined value, the light detection device may choose to enter the strong light mode. In one example, when detecting that the current ambient light intensity is continuously greater than the second predetermined value for a second period of time, the light detection device may choose to enter the strong light mode.

It should be understood that the different working parameters corresponding to the different working modes mentioned here may refer to different values of the working parameters of the same type, or different types of working parameters.

For example, take one of the following filtering strategies as an example. Different working modes may have this filtering strategy, but the parameters in the filtering strategy may be different, or some working modes may have the filtering strategy, and some working modes may not have the filtering strategy.

For example, in the working mode corresponding to the weather type of haze, the transmission power of the pulse sequence may be larger than the transmission power of the pulse sequence of the working mode corresponding to the normal weather, but there may be no filtering strategy. In the working mode corresponding to rain, the transmission power of the pulse sequence may be the same as the transmission power of the working mode corresponding to the normal weather, but compared to the normal weather working mode, there may be a filtering strategy.

It should be understood that in the embodiments of the present disclosure, the light detection device may not have various working mode setting. At this time, the light detection device may adjust at least one of the working parameters used in the light detection process based on the obtained environment parameter.

In some embodiments, the types of working parameters adjusted each time may be different. For example, when the environment parameter indicate that the light rain has changed to moderate rain, the transmission power may be adjusted, and when the environment parameter indicate that the light rain has change to heavy rain, the filtering strategy may be added while adjusting the transmission power.

Take the working phases of light detection as an example, the working parameters determined by the environment parameter may include at least one of a parameter when transmitting the pulse sequence, a parameter when sampling the electrical signal converted from the reflected pulse sequence, a parameter for processing the results obtained by sampling the electrical signals, and a parameter for processing an image obtained by arranging the point cloud information based on the position.

That is, at least one of the above working parameters may be associated with an environment parameter, and may be change as the environment parameter changes.

If the light detection device is provided with multiple working modes, at least one of the above working parameters among the parameters corresponding to each working mode may be different.

Optionally, in the embodiments of the present disclosure, the parameter when transmitting the pulse sequence obtained from the environment parameter may include at least one of a power of the transmitted pulse sequence, a frequency of the transmitted power sequence, a speed at which the exit path of the pulse sequence changes, and a scanning range or scanning pattern of the emitted pulse sequence.

In some embodiments, in different working modes, at least one of the above parameters may be different.

More specifically, in different environments, the number of abnormal particle objects in the air may be different and the degree of impact on the attenuation of the pulse sequence may be different, and the power and/or frequency of the transmitted pulse sequence may be determined based on the environment parameter. If the attenuation caused by the environment is relatively high, a higher transmission power and/or frequency may be configured to transmit the pulse sequence. For example, in the case of a sunny day, if the attenuation of the pulse sequence is relatively low, the power and/or frequency of the transmitted pulse sequence may be relatively low. In the case of a rainy day, the higher the attenuation of the pulse sequence, the higher the power and/or frequency of the transmitted pulse sequence, and the greater the rainfall, the high the power and/or frequency of the transmitted pulse sequence. In another example, in the absence of haze, the power of the transmitted pulse sequence may be relatively low. In the present of haze, the power of the transmitted pulse sequence may be relative high, and the more severe the haze, the higher the power of the transmitted pulse sequence.

Since the number of abnormal particle objects in the air may be different in different environments, the impact on the attenuation of the pulse sequence may be different. If the attenuation is relatively high, the measurement information may not be obtained normally. In addition, due to the increase of abnormal particle objects, the proportion of pulse sequences reflected by normal objects may be reduced under the same number of pulses. Therefore, a more important area that needs to be measure may be selected, and a focused measurement may be performed on the more important area. At this time, it is possible to focus on detecting a certain area by changing the scanning range or scanning pattern of the emitted pulse sequence.

More specifically, the scanning range or scanning pattern may be changed by changing the speed at which the exit path of the pulse sequence changes. More specifically, the speed at which the exit path of the pulse sequence changes may be adjusted by changing the rotation speeds of the first optical element 214 and the second optical element 215 in the light detection device shown in FIG. 2.

For example, for the area that needs to be detected, when the pulse sequence is transmitted to the area, the first optical element 214 and the second optical element 215 may be made to rotate more slowly, such that more pulse sequences can be emitted for this area. For the less important areas, when the pulse sequence is transmitted to these areas, the first optical element 214 and the second optical element 215 may be made to rotate faster, such that more pulse sequences can be emitted for these areas.

Alternatively, the scanning range or scanning pattern may also be changed by controlling the rotation angles of the first optical element 214 and the second optical element 215. If certain areas do not need to be detected, the rotation angles of the first optical element 214 and the second optical element 215 may be adjusted, such that the pulse sequence does not need to be emitted to these areas.

Optionally, in the embodiments of the present disclosure, the parameters for sampling the electrical signal converted from the reflected pulse sequence obtained from the environment parameter may include a sampling frequency for sampling the electrical signal, and/or a minimum sampling threshold for sampling the electrical signal converted from the reflected pulse sequence.

In some embodiments, in different working modes, the sampling frequency for sampling the electrical signal may be different.

More specifically, in different environments, the number of abnormal particle objects in the air may be different and the degree of impact on the attenuation of the pulse sequence may be different, and the degree of impact of the attenuation may be adapted by changing the sampling frequency of the electrical signal. If the attenuation caused by the environment is relatively high, a higher sampling frequency may be configured to sample the electrical signal. For example, in the case of a sunny day, the attenuation of the pulse sequence may be relatively low, and the sampling frequency for sampling the electrical signal may be relatively low. In the case of a rainy day, the attenuation of the pulse sequence may be relatively high, the sampling frequency for sampling the electrical signal may be high, and the greater the rainfall, the higher the sampling frequency for sampling the electrical signal.

Optionally, in the embodiments of the present disclosure, the parameter for processing the result obtained by sampling the electrical signal obtained from the environment parameter may include a parameter for amplifying the electrical signal obtained by sampling, and a parameter for filtering the result obtained by sampling.

In some embodiments, in different working modes, at least one of the above parameters may be different.

More specifically, in different environments, the number of abnormal particle objects in the air may be different, and the degree of impact on the attenuation of the pulse sequence may be different. Therefore, the magnification of the electrical signal obtained by acquisition may be changed with the change of the environment. In some embodiments, the higher the attenuation caconfigured to the pulse sequence, the higher the magnification of the amplification may be, and the lower the attenuation caconfigured to the pulse sequence, the lower the magnification of the amplification may be. For example, in the case of a sunny day, the attenuation of the pulse sequence may be relatively low, and the magnification of the amplification may be relatively low. In the case of a rainy day, the attenuation of the pulse sequence may be relatively high, the magnification of the amplification may be relatively high, and the greater the rainfall, the higher the magnification of the amplification may be.

The aforementioned strategy for filtering out the results obtained by sampling may include a bottom layer filtering strategy (hereinafter referred to as a first filtering strategy) and an application layer filtering strategy (hereinafter referred to as a second filtering strategy). The first filtering strategy and the second filtering strategy mentioned below may be configured to filter the electrical signal obtained after sampling the electrical signal obtained by photoelectric conversion.

In some embodiments, the first filtering strategy may be determining that the electrical signal needs to be filtered out when the distance between the reflector corresponding to the electrical signal obtained by photoelectric conversion and the detection device is within a first distance threshold, and the peak value of the electrical signal is less than a first peak threshold. In some embodiments, the first distance threshold may include two thresholds, a maximum value and a minimal value, that is, it may be needed to determine whether the distance between the reflector and the detection device is within a distance range. Since the transmission speed of light is constant, the transmission time of the light pulse sequence between the reflector and the detection device may reflect the distance between the reflector and the detection device, and the distance between the reflector and the detection device may be characterized by the transmission time of the pulse sequence between the two.

In addition, the first peak threshold may be a voltage threshold, and it may be determined whether the waveform of the electrical signal triggers the voltage threshold.

More specifically, when a target waveform corresponding to the electrical signal does not trigger the first peak threshold, the target waveform may be determined to be filtered. In some embodiments, the return time and/or return distance of the target waveform may be within a return time range and/or a return distance range.

That is, the return time and/or return distance may be set. If the return time and/or return distance of the waveform are within the return time range and/or return distance range, a determination on whether to filter the electrical signal may be performed. The specific criterion may include determining whether the waveform has triggered the first peak threshold. If the first peak threshold is triggered, the electrical signal may not need to be filtered, if the first peak threshold is not triggered, the electrical signal may need to be filtered. In some embodiments, the first peak threshold here may be one or more of the voltage thresholds at the time of sampling. For example, it may be the maximum value or the second largest value among the voltage thresholds at the time of sampling.

For example, assume that the voltage threshold during sampling is 1 v, 2 v, and 3 v. The electrical signal triggers one of the thresholds, which may be used as a sampling point. After all the electrical signals are sampled, it may be determined that the sampled data has triggered 3 v (i.e., the first peak threshold). If it is triggered, it may not need to be filtered. If it is not triggered, it may be filtered.

In some embodiments, if the return time and/or return distance of the waveform are not within the return time range and/or return distance range, the waveform may not be filtered.

In some embodiments, for different working modes, the first peak threshold mentioned above may be different. The more and larger the particle objects exist in the environment, the larger the first peak threshold may be. For example, for heavy rain, it may be needed to determine whether the threshold of 3 v is triggered, for moderate rain, it may be needed to determine whether the threshold of 2 v is triggered, and for light rain, it may be needed to determine whether the threshold of 1 v is triggered.

Alternatively, for different working modes, the first peak threshold mentioned above may be different. That is, the corresponding return time range and/or return distance range may be different. In some embodiments, the return time may be the return time between the reflector and the light detection device, or the time from the transmission of the pulse sequence to the reception of the pulse sequence. The return distance may be the distance between the reflector and the light detection device, or the sum of the distance from the light detection device to the reflector, and from the reflector to the light detection device.

In some embodiments, the more and larger the particle objects exist in the environment, the smaller the interval of the return time range and/or return distance range may be. For example, for light rain, the return distance range may be 0-30 meters, for moderate rain, the return distance range may be 2-25 meters, and for heavy rain, the return distance range may be 10-20 meters.

In the embodiments of the present disclosure, in some working modes, the first filtering strategy may exist, and in some working modes, the first filtering strategy may not exist.

For example, for a special weather working mode, the first filtering strategy may exist, while for a normal weather working mode, the first filtering strategy may not exist. At this time, when the special weather working mode is determined based on the environment parameter, the first filtering strategy may be used for filtering.

For the special weather working mode, when the distance between the reflector corresponding to the electrical signal and the detection device is within the first distance threshold, and the peak value of the electrical signal is less than the first peak threshold, the reflector corresponding to the electrical signal may be a particle object in the special weather, such that the electrical signal needs to be filtered out.

In some embodiments, the special weather working mode may include at least two special weather working modes. The at least two special weather working modes may include special weather working modes corresponding to different types of weather, or include different degrees of special weather working modes corresponding to the same type of weather. In some embodiments, in different special weather working modes, the first distance threshold and/or the first peak threshold may be different.

In some embodiments, the second filtering strategy may include filtering using a filtering model. In some embodiments, when using the filtering model to filter, the result obtained by sampling (which can be referred to as a sampled waveform) may be input into the model. The output result of the model may be whether to filter the waveform, or output the probability of filtering the waveform. If the probability exceeds a certain value, other determination method may be configured to determine whether to perform the filtering, and if the probability is less than a certain value, no filtering may be performed. Alternatively, if the probability exceeds a certain value, filtering may be performed directly, and if the probability is less than a certain value, other determination method may be configured to determine whether to perform the filtering.

In some embodiments, in different working modes, the filtering model may be different. After the working mode is obtained based on the environment parameter, the corresponding filtering model may be selected based on the working mode.

For example, there may be a normal weather working mode and a special weather working mode.

For the special weather working mode, the filtering model may be configured to determine whether the reflector of the pulse sequence is a normal object or a particle object in the special weather.

Optionally, in the embodiments of the present disclosure, when the reflector is determined to be a particle object in the special weather based on the filtering strategy, the corresponding electrical signal may be filtered out directly. Alternatively, when the reflector is determined to be a particle object in the special weather based on the filtering strategy, other methods may also be configured to determine whether the reflector is reflector is a particle object, and then whether to perform filtering may be determined after combining the determinations result of the other methods.

Optionally, in the embodiments of the present disclosure, a machine learning method may be configured to perform cluster analysis on the electrical signals corresponding to the normal objects and the electrical signals corresponding to particle object in the special weather, and train the filtering model online. At this time, the filtering model may optionally be applied to the special weather working mode.

In some embodiments, the filtering model may also be optimized in real time. For example, the user may determine whether the determination result of the filtering model is accurate, and input a user determination into the model to optimize the model.

Similar to the first filtering strategy, in the embodiments of the present disclosure, the second filtering strategy may exist in some working modes (e.g., the special weather working mode), while in come working modes (e.g., the normal weather working mode), the second filtering strategy may not exist.

The first filtering strategy and the second filtering strategy are described above, and there may be other filtering strategies in the embodiments of the present disclosure, such as a strategy for filtering points in an image obtained based on the point cloud information within a certain period of time, which may be referred to as a third filtering strategy below.

The generation of an image will be described below, which may include sampling the electrical signal converted from the reflected pulse sequence to obtain the sampling result; calculating the distance between the reflector of the reflected pulse sequence and the detection device based on the sampling result to obtain a point cloud, where each point in the point cloud may include distance information between the detection device and a reflector; and mapping the point cloud within a certain period of time into a frame of image. When mapping the point cloud information within a certain period of time into an image, the image information may be mapped based on a positional relationship between points. At this time, each point may be understood as a point with three-dimensional coordinates. Further, each point may also include reflectance information.

Since the points corresponding to the abnormal particle objects in the special weather may be understood as white noise point, the positional relationship between adjacent points may be randomly distributed. In addition, the distribution of coordinate information between adjacent points on a normal object may have a pattern. Based on this, the points corresponding to the abnormal particle objects may be filtered out by analyzing the positional relationship between adjacent points within a certain distance on the image.

Based on this, the third filtering strategy mentioned above may indicate that the distance indicated by the distance information included in the points to be filtered is within a second distance threshold, and the difference between the distance indicated by the distance information included in the points to be filtered out and the distance indicated by the distance information included in the adjacent point is less than or equal to a third distance threshold.

The foregoing uses the distance as a reference to determine whether to filter out a certain point. In the embodiments of the present disclosure, the reflectance may also be used as a reference to determine whether to filter out a certain point. For example, the third filtering strategy may indicate that the distance indicated by the distance information included in the points to be filtered out is within a first reflectance threshold, and the difference between the distance indicated by the distance information included in the points to be filtered out and the distance indicated by the distance information included in the adjacent point is less than or equal to the first distance threshold. Of course, the reflectance and distance may be considered together.

For the third filtering strategy, the third filtering strategy may be configured to determine whether the reflector is a normal object or an abnormal particle object in the special weather.

In some embodiments, in different working modes, the second distance threshold and/or the third distance threshold may be different. Alternatively, in different working modes, a first reflectance threshold and/or a second reflectance threshold may be different.

In some embodiments, the special working mode may include at least two special weather working modes. The at least two special weather working modes may include a special weather working mode corresponding to different types of weather, or a special weather working mode of different degrees corresponding to the same type of weather. In some embodiments, in different working modes, the second distance threshold and/or the third distance threshold may be different, or the first reflectance threshold and/or the second reflectance threshold may be different.

Optionally, in the embodiments of the present disclosure, in some working modes, the third filtering strategy may exist, while in some working modes, the third filtering strategy may not exist.

For example, for the special weather working mode, the third filtering strategy may exist, while for the normal weather working mode, the third filtering strategy may not exist. At this time, when performing the special weather working mode based on the environment parameter, the third filtering strategy may be used for filtering.

In some embodiments, for the third filtering strategy, the classic octree method, spatial grid method, k-d tree, through filtering, statistical filtering, radius filtering, bilateral rate wave, voxel grid filtering, and triangular grid reconstruction methods may be used for filtering.

A variety of filtering strategies are described above. For different working modes, the above-mentioned different filtering strategies may be used. For example, the first filtering strategy and the second filtering strategy may be used for the first working mode, the second filtering strategy may be used for the second working mode, and the third filtering strategy may be used for the third working mode.

Alternatively, the types of filtering strategies adopted by different working modes may be the same, but the parameters in the filtering strategies may be different.

Optionally, in the embodiments of the present disclosure, the light detection device may first determine whether the reflector is a normal object or a particle object in a special weather based on the above strategies, and then perform filtering processing when the reflector is determined to be a particle object in the special weather.

In some embodiments, the electrical signal may be directly filtered if the reflector is determined as a particle object in the special weather based on the filtering strategy. Alternatively, when the reflector is determined as a particle object in the special weather, other methods may be configured to determine whether the reflector is a particle object, and then the determination result of the other method may be combined to determine whether to perform filtering.

Alternatively, in the embodiments of the present disclosure, the light detection device may not need to know whether the reflector is a normal object or a particle object in a special weather, and it may only need to determine whether the result of a certain electrical signal meets a certain condition. If the condition is met, the electrical signal may be filtered, and if the condition is not met, the electrical signal may not be filtered.

In the embodiments of the present disclosure, since in different environments, the characteristics of the echo may not be the same, therefore, the use of filtering strategies may be combined with weather parameters. This can avoid the use of the same filtering method for sampling under different weather conditions, thereby avoiding incorrect operation of the normal waveforms, avoiding the loss of effective information, and making the light detection device suitable for different environmental conditions.

Since the environment parameter may change in real time, the light detection device may periodically obtain the environment parameter, such that the working parameters during light detection may be adjusted based on the environment parameter in time, thereby further improving the accuracy of light detection.

The workflow of an embodiment of the present disclosure will be described by taking a radar as an example in conjunction with FIG. 5. The workflow shown in FIG. 5 may be implemented periodically.

In 510, the weather parameters are entered in the radar. In 520, the radar can determine the weather type and determine whether the weather type has changed, and if it changes, in 540, the radar can switch to a matching working mode, if it has not changed, in 550, the current state is maintained.

Therefore, in the embodiments of the present disclosure, by determining the working parameters or working modes when performing light detection based on the environment parameter, the impact of the environment can be taken into consideration when performing light detection, and the issue of low measurement accuracy caused by the environment on the light detection can be avoided, and it is especially suitable for light detection in an abnormal environment.

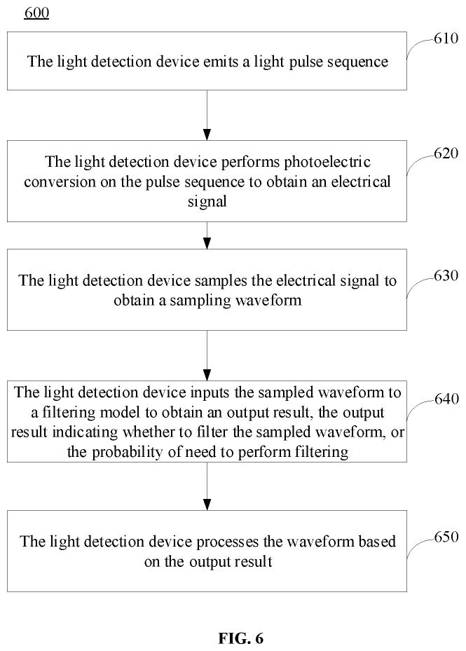

FIG. 6 is a flowchart of a light detection method 600 according to an embodiment of the present disclosure. The method 600 includes at least a part of the following content

In 610, the light detection device emits the light pulse sequence.

In 620, the light detection device performs photoelectric conversion on the light pulse sequence to obtain an electrical signal.

In 630, the light detection device samples the electrical signal to obtain a sample waveform.

In 640, the light detection device inputs the sampled waveform to a filtering model to obtain an output result, the output result indicating whether to filter the sampled waveform, or a probability that the waveform needs to be filtered.

In 650, the light detection device processes the waveform based on the output result.

Optionally, in the embodiments of the present disclosure, a machine learning algorithm may be configured to train the filtering model.

In some embodiments, when using the filtering model to filter, the result obtained by sampling (which can be referred to as a sampled waveform) may be input into the model. The output result of the model may be whether to filter the waveform, or output the probability of filtering the waveform. If the probability exceeds a certain value, other determination method may be configured to determine whether to perform the filtering, and if the probability is less than a certain value, no filtering may be performed. Alternatively, if the probability exceeds a certain value, filtering may be performed directly, and if the probability is less than a certain value, other determination method may be configured to determine whether to perform the filtering.

Optionally, in the embodiments of the present disclosure, the filtering model may also be optimized in real time. For example, the user may determine whether the determination result of the filtering model is accurate, and input a user determination into the model to optimize the model.

Therefore, in the embodiments of the present disclosure, the electrical signal obtained by photoelectric conversion of the reflected pulse sequence can be sampled, and the sampled waveform can be input to the filtering model to obtain the output result. The output result can indicate whether to filter the sampled waveform, or the probability that the waveform needs to be filtered. Further, based on the output result, the waveform can be processed to filter out the impact of the waveform from the abnormal reflectors on the light detection accuracy, and the sampling filtering model can determine whether to filter the sampled waveform, which is relatively simple to implement and can improve the processing efficiency during light detection.

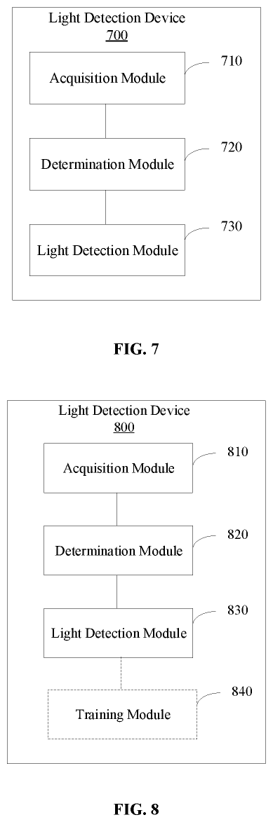

FIG. 7 is a schematic diagram a light detection device 700 according to an embodiment of the present disclosure. The light detection device 700 may include an acquisition module 710, a determination module 720, and a light detection module 730.

In some embodiments, the acquisition module 710 may be configured to obtain the environment parameter during light detection; the determination module 720 may be configured to determine the working parameters for light detection based on the environment parameter acquired by the acquisition module; and the light detection module 730 may be configured to perform light detection based on the working parameters determined by the determination module. In some embodiments, the light detection may be configured to calculate the distance between the light detection device and the reflector based on the transmitted pulse sequence and the reflected pulse sequence reflected by the reflector.

Optionally, in the embodiments of the present disclosure, the working parameters may include at least one of a parameter when transmitting the pulse sequence, a parameter when sampling the electrical signal converted from the reflected pulse sequence, a parameter for processing the results obtained by sampling the electrical signals, and a parameter for processing an image obtained by arranging the point cloud information based on the position.

Optionally, in the embodiments of the present disclosure, the parameter when transmitting the pulse sequence may include at least one of a power of the transmitted pulse sequence, a frequency of the transmitted power sequence, a speed at which the exit path of the pulse sequence changes, and a scanning range or scanning pattern of the emitted pulse sequence.

Optionally, in the embodiments of the present disclosure, the parameter for sampling the electrical signal converted from the reflected pulse sequence may include a sampling frequency for sampling the electrical signal.

Optionally, in the embodiments of the present disclosure, the parameter for processing the result obtained by sampling the electrical signal may include at least one of a parameter for filtering the result obtained by sampling, and a parameter for amplifying the electrical signal obtained by sampling.

Optionally, in the embodiments of the present disclosure, the parameter for filtering the result obtained by sampling may include the return time range and/or the return distance range corresponding to the waveform that may need to be filtered out, and the set first peak threshold. In some embodiments, in performing the filtering determination of the target waveform, when the target waveform does not trigger the first peak threshold, the target waveform may be determined to be filtered, where the return time and/or the return distance of the target waveform may be within the return time range and/or the return distance range corresponding.

Optionally, in the embodiments of the present disclosure, the parameter for filtering the result obtained by sampling may include a model configured to filter the result.

Optionally, in the embodiments of the present disclosure, the light detection module 730 may be further configured to input the sampled result into the model to obtain the output result, the output result indicating whether to filter the sampled result or the probability that the sampled result needs to be filtered; and process the result obtained by sampling based on the output result.

Optionally, in the embodiments of the present disclosure, the parameter for amplifying the electrical signal obtained by sampling may include a magnification of the electrical signal obtained by sampling.

Optionally, in the embodiments of the present disclosure, the parameter for processing the image obtained by arranging the point cloud information based on the position may include the return distance range corresponding to the points on the image that may need to be filtered out, and the distance difference threshold and/or the reflectance different threshold between the point to be filtered and the adjacent point. In some embodiments, in performing the target point filtering determination, when the distance difference and/or the reflectance different between the target point and the adjacent point is greater than or equal to the distance threshold and/or the reflectance threshold, determine that the target point need to be filtered out.

Optionally, in the embodiments of the present disclosure, the acquisition module 710 may be further configured to acquire the environment parameter from an external device through a communication link.

Optionally, in the embodiments of the present disclosure, the environment parameter may include an environment type and/or a degree of characterization under a specific weather.

Optionally, in the embodiments of the present disclosure, the values of the working parameters corresponding to different environment types and/or degree of characterization interval may be different.

Optionally, in the embodiments of the present disclosure, the environment parameter may include a weather parameter and/or a light parameter.

Optionally, in the embodiments of the present disclosure, the weather parameter may include a weather type, and the weather type may include rain, snow, fog, haze, or sandstorm.

Optionally, in the embodiments of the present disclosure, the weather type may be rain, and the acquisition module 710 may be further configured to obtain the rainfall amount through an on-board windshield wiper or an on-board rain gauge.

Optionally, in the embodiments of the present disclosure, the specific implementation of the light detection device 700 may be the light detection device described in FIG. 1 and FIG. 2.

For example, the acquisition module 710 and the determination module 720 may be implemented by the control circuit 150 shown in FIG. 1. The light detection module 730 may be implemented by the transmitting circuit 110, the receiving circuit 120, the sampling circuit 130, and the arithmetic circuit 140 as shown in FIG. 1.

For example, in some embodiments, the light detection module may include a detector. The light detection module may further include a light source for emitting light pulse sequence; a scanning module including at least one optical element that moves relative to the light source and configured to sequentially change the light pulse sequence from the light source to different propagation directions to emit, and transmit the light pulse sequence reflected by the reflector to the detector after passing through the scanning module. The detector may be used for calculating the distance between the light detection device and the reflector based on the transmitted pulse sequence and the pulse sequence reflected by the reflector.

For example, in some embodiments, the scanning module may include at least two rotating prisms, and the at least two rotating prisms may be sequentially positioned on the propagation light path of the light pulse sequence, and configured to sequentially change the light pulse sequence to different propagation directions.

It should be understood that the light detection device 700 may be configured to implement the above method 300 and the methods in its optional implementations, and for the sake of brevity, details are not repeated here.

FIG. 8 is a schematic diagram a light detection device 800 according to an embodiment of the present disclosure. The light detection device 800 may include an acquisition module 810, a determination module 820, and a light detection module 830.

In some embodiments, the acquisition module 810 may be configured to obtain the environment parameter during light detection; the determination module 820 may be configured to determine the working mode for light detection, where different working modes may correspond to different working parameters; and the light detection module 830 may be configured to perform light detection based on the working mode determined by the determination module. In some embodiments, the light detection may be configured to calculate the distance between the light detection device and the reflector based on the transmitted pulse sequence and the reflected pulse sequence reflected by the reflector.

Optionally, in the embodiments of the present disclosure, at least one of the following working parameters corresponding to the different working modes may be different: the power of the transmitted pulse sequence, the frequency of the transmitted pulse sequence, the scanning range or scanning pattern of the transmitted pulse sequence, the magnification of the electrical signal converted from the reflected pulse sequence, the sampling frequency for sampling the electrical signal converted from the reflected pulse sequence, and the filtering strategy, the filtering strategy being configured to filter the processing result corresponding to the reflected pulse sequence.

Optionally, in the embodiments of the present disclosure, the determination module 820 may be further configured to determine the mode for light detection being a special working mode based on the environment parameter obtained by the acquisition module. In some embodiments, in the special weather working mode, the light detection may include converting the reflected pulse sequence into electrical signals; and based on the filtering strategy, determining whether to filter the electrical signal, and filter the electrical signal that needs to be filtered. In some embodiments, the reflector corresponding to the electrical signal that needs to be filtered may be a particle object in the special weather, and the reflector corresponding to the electrical signal that does not need to be filtered may be a normal object.

Optionally, in the embodiments of the present disclosure, the filtering strategy may include a first filtering strategy. The first filtering strategy may indicate that when the distance between the reflector corresponding to the electrical signal and the light detection device is within the first distance threshold, and the peak value of the electrical signal is less than the first peak threshold, determine that the electrical signal needs to be filtered out.

Optionally, in the embodiments of the present disclosure, the special weather working mode may include at least two special weather working modes. The at least two special weather working modes may include special weather working modes corresponding to different weather types, or special weather working modes of different degrees of the same weather type.

In some embodiments, in different special weather working modes, the first distance threshold and/or the first peak threshold may be different.

Optionally, in the embodiments of the present disclosure, the filtering strategy may include a second filtering strategy. The second filtering strategy may indicate using the filtering model to determine whether to filter the electrical signal or the probability of filtering, where the filtering model may include the parameter characteristics of the electrical signal when the reflector is a normal object and/or the parameter characteristics of the electrical signal when the reflector is a particle object in the special weather.

Optionally, in the embodiments of the present disclosure, the working mode may include at least one of a strong light working mode, a normal light working mode, and a dark light working mode.

Optionally, in the embodiments of the present disclosure, determining the working mode for light detection may include selecting to enter the dark mode when detecting the current ambient light intensity is lower than the first predetermine value, or when detecting that the current ambient light intensity is continuously lower than the first predetermined value for the first period of time, or based on the current local time.

In some embodiments, determining the working mode for light detection based on the obtained environment parameter may include selecting to enter the strong light mode when detecting that the current ambient light intensity is greater than the second predetermined value, or when detecting that the current ambient light intensity is continuously greater than the second predetermined value for the second period of time.

Optionally, in the embodiments of the present disclosure, as shown in FIG. 8, the device 800 further include a training module 840 configured to use a machine learning device to perform cluster analysis on electrical signals corresponding to the normal objects and electrical signals corresponding to particle objects in the special weather, and train the filtering model online.

Optionally, in the embodiments of the present disclosure, the light detection may include sampling the electrical signal converted from the reflected pulse sequence to obtain the sampling result; calculate the distance between the reflector corresponding to the pulse sequence and the light detection device based on the sampling result to obtain a point cloud, where each point in the point cloud may include distance information between the light detection device and one reflector; map the point cloud within a certain period of time into a frame of image; and perform noise filtering on the image based on the filtering strategy.

Optionally, in the embodiments of the present disclosure, each point may further the reflectance of the one reflector.

Optionally, in the embodiments of the present disclosure, the determination module 820 may be further configured to determine the mode for light detection is a special weather working mode based on the environment parameter obtained by the acquisition module. In some embodiments, in the special weather working mode, the light detection may include filtering out the points belonging to the particle objects in the special weather in the image based on the filtering strategy.

Optionally, in the embodiments of the present disclosure, the filtering strategy may include a third filtering strategy. The third filtering strategy may indicate that the distance indicated by the distance information included in the point to be filtered is within the second distance threshold, and the difference between the distance indicated by the distance information included in the point to be filtered and the distance indicated by the distance information included in the adjacent point is less than or equal to the third distance threshold.

Optionally, in the embodiments of the present disclosure, the special weather working mode may include at least two special weather working modes. The at least two special weather working modes may include special weather working modes corresponding to different weather types, or special weather working modes of different degrees of the same weather type.

In some embodiments, in different special weather working modes, the second distance threshold and/or the third distance threshold may be different.

Optionally, in the embodiments of the present disclosure, the acquisition module 810 may be further configured to acquire the environment parameter from an external device through a communication link.

Optionally, in the embodiments of the present disclosure, the environment parameter may include an environment type and/or a degree of characterization under a specific weather.

Optionally, in the embodiments of the present disclosure, the values of the working parameters corresponding to different environment types and/or degree of characterization interval may be different.

Optionally, in the embodiments of the present disclosure, the environment parameter may include a weather parameter and/or a light parameter.

Optionally, in the embodiments of the present disclosure, the weather parameter may include a weather type, and the weather type may include rain, snow, fog, haze, or sandstorm.

Optionally, in the embodiments of the present disclosure, the weather type may be rain, and the acquisition module 810 may be further configured to obtain the rainfall through an on-board windshield wiper or an on-board rain gauge.

Optionally, in the embodiments of the present disclosure, the specific implementation of the light detection device may be the light detection device described in FIG. 1 and FIG. 2.

For example, the acquisition module 810, the determination module 820, and the training module 840 may be implemented by the control circuit 150 shown in FIG. 1. The light detection module 830 may be implemented by the transmitting circuit 110, the receiving circuit 120, the sampling circuit 130, and the arithmetic circuit 140 as shown in FIG. 1.

For example, in some embodiments, the light detection module may include a detector. The light detection module may further include a light source for emitting light pulse sequence; a scanning module including at least one optical element that moves relative to the light source and configured to sequentially change the light pulse sequence from the light source to different propagation directions to emit, and transmit the light pulse sequence reflected by the reflector to the detector after passing through the scanning module. The detector may be used for calculating the distance between the light detection device and the reflector based on the transmitted pulse sequence and the pulse sequence reflected by the reflector.

In some embodiments, the scanning module may include at least two rotating prisms, and the at least two rotating prisms may be sequentially positioned on the propagation light path of the light pulse sequence, and configured to sequentially change the light pulse sequence to different propagation directions.

It should be understood that the light detection device 800 may be configured to implement the above method 400 and the methods in its optional implementations, and for the sake of brevity, details are not repeated here.

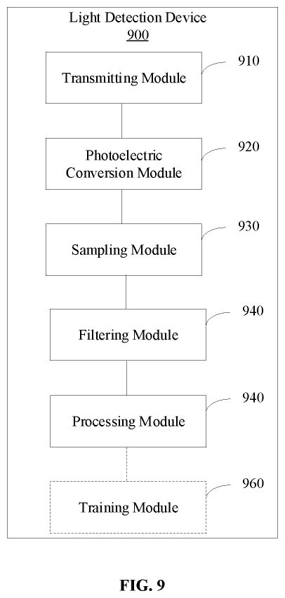

FIG. 9 is a schematic diagram a light detection device 900 according to an embodiment of the present disclosure. As shown in FIG. 9, the light detection device 900 includes a transmitting module 910, a photoelectric conversion module 920, a sampling module 930, a filtering module 940, and a processing module 950.

In some embodiments, the transmitting module 910 may be configured to transmit a light pulse sequence. The photoelectric conversion module 920 may be configured to perform photoelectric conversion on the pulse sequence to obtain an electrical signal. The sampling module 930 may be configured to sample the electrical signal to obtain a sampling waveform. The filtering module 940 may be configured to input the sampled waveform into the filtering model to obtain an output result, the output result indicating whether to filter the sampled waveform, or the probability of performing the filtering. The processing module 950 may be configured to process the waveform based on the output result.

In some embodiments, as shown in FIG. 9, the light detection device 900 can further include a training module 960 configured to use machine learning algorithms to train the filtering model online.

Optionally, in the embodiments of the present disclosure, the processing module 950 may be further configured to continue to perform filtering determination when the output result indicates that the probability of filtering is greater than a predetermined value; and processing the waveform based on the filtering determination result.

Optionally, in the embodiments of the present disclosure, the processing module 950 may be further configured to not filtering the waveform when the output result indicates that the probability of filtering is less than the predetermined value.

Optionally, in the embodiments of the present disclosure, the specific circuit implementation of the light detection device may be the light detection device described in FIG. 1 and FIG. 2.

For example, the transmitting module 910 may be implemented by the transmitting circuit 110 shown in FIG. 1, the photoelectric conversion module 920 may be implemented by the receiving circuit 120 shown in FIG. 1, the sampling module 930 may be implemented by the sampling circuit 130 shown in FIG. 1, and the filtering module 940, the processing module 950, and the training module 960 may be implemented by the control circuit 150.

For example, in some embodiments, the light detection device may further include a scanning module including at least one optical element that moves relative to the light source and configured to sequentially change the light pulse sequence from the light source to different propagation directions to emit, and transmit the light pulse sequence reflected by the reflector to the photoelectric conversion module after passing through the scanning module. The processing module may be used for calculating the distance between the light detection device and the reflector based on the transmitted pulse sequence and the pulse sequence reflected by the reflector.

In some embodiments, the scanning module may include at least two rotating prisms, and the at least two rotating prisms may be sequentially positioned on the propagation light path of the light pulse sequence, and configured to sequentially change the light pulse sequence to different propagation directions.

It should be understood that the light detection device 900 may be configured to implement the foregoing method 600 and the methods in its optional implementation manner. For brevity, details will not be repeated here.

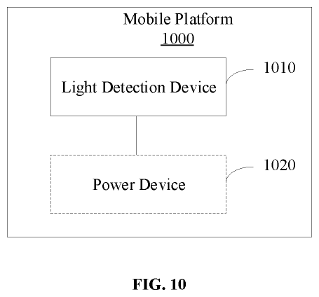

FIG. 10 is a schematic block diagram of a mobile platform 1000 according to an embodiment of the present disclosure. The mobile platform 1000 may include a light detection device 1010, and optionally may include a power device 1020, and the like.

The power device 1020 can provide power for the mobile platform. The light detection device can be configured to implement the methods 300, 400, and 600, and its specific structure may be the light detection device shown in FIG. 1, FIG. 2, FIG. 7, FIG. 8, and FIG. 9. For brevity, details will not be repeated here.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

It can be appreciated by those skilled in the art that for the specific working process of the system, the apparatus, and the module described above, reference can be made to the corresponding process in the foregoing embodiments of the method, and the details description is omitted herein for the convenience and brevity of the description.

In the embodiments of the present disclosure, the disclosed system, apparatus, and method may be implemented in other manners. For example, the embodiments of the apparatus described above are merely illustrative. For example, the division of units/circuits may only be a logical function division, and there may be other ways of dividing the units/circuits. For example, multiple units or circuits may be combined or may be integrated into another system, or some feature may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

The functional units consistent with the disclosure can be implemented in the form of computer program stored in a non-transitory computer-readable storage medium, which can be sold or used as a standalone product. The computer program can include instructions that enable a computer device, such as a personal computer, a server, or a network device, or a processor, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

The above descriptions only illustrate some embodiments of the present disclosure. The present disclosure is not limited the described embodiments. A person having ordinary skill in the art may conceive various equivalent modifications or replacements based on the disclosed technology. Such modification or improvement also fall within the scope of the present disclosure. A true scope and spirit of the present disclosure are indicated by the following claims.

What is claimed is:

1. A light detection method comprising:
obtaining an environment parameter for performing light detection;
determining a working mode for performing light detection based on the obtained environment parameter, wherein different working modes correspond to different working parameters; and
performing light detection based on the determined working mode, wherein the light detection is configured to calculate a distance between a light detection device and a reflector based on a transmitted pulse sequence and a reflected pulse sequence reflected by the reflector.

2. The method of claim 1, wherein the different working parameters corresponding to the different working modes include at least one of:
a power of the transmitted pulse sequence, a frequency of the transmitted pulse sequence, a scanning range or a scanning pattern of the transmitted pulse sequence, a magnification of an electrical signal converted from the reflected pulse sequence, a sampling frequency for sampling the electrical signal converted from the reflected pulse sequence, a minimal sampling threshold for sampling the electrical signal converted from the reflected pulse sequence, and a filtering strategy, the filtering strategy being configured to filter a processing result corresponding to the reflected pulse sequence.

3. The method of claim 1, wherein determining the working mode for performing the light detection based on the obtained environment parameter includes:
determining that a mode for performing the light detection is a special weather working mode based on the obtained environment parameter,
in the special weather working mode, the light detection including:
converting the reflected pulse sequence into the electrical signal; and
determining whether to filter the electrical signal based on the filtering strategy and filtering the electrical signal that needs to be filtered, the reflector corresponding to the electrical signal that needs to be filtered being a particle object in a special weather, and the reflector corresponding to the electrical signal that does not need to be filtered being a normal object.

4. The method of claim 3, wherein:
the filtering strategy includes a first filtering strategy, and the first filtering strategy indicates: when the distance between the reflector corresponding to the electrical signal and the light detection device is within a first distance threshold, and a peak value of the electrical signal is less than a first peak threshold, determining that the electrical signal needs to be filtered.

5. The method of claim 4, wherein:
the special weather working mode includes at least two special weather working modes, the at least two special weather working modes including special weather working modes corresponding to different weather types, or including different degrees of special weather working modes of a same weather type, the first distance threshold and/or the first peak threshold being different in different special weather working modes.

6. The method of claim 3, wherein:
the filtering strategy includes a second filtering strategy, the second filtering strategy indicating using a filtering model to determine whether to filter the electrical signal or a probability of filtering; and
the filtering model includes parameter characteristics of the electrical signal when the reflector is the normal object and/or the parameter characteristics of the electrical signal when the reflector is the particle object in the special weather.

7. The method of claim 6, further comprising:
using machine learning methods to perform cluster analysis on the electrical signal corresponding to the normal object and the electrical signal corresponding to the particle object in the special weather; and
online training the filtering model.

8. The method of claim 1, wherein the light detection includes:
sampling the electrical signal converted from the reflected pulse sequence to obtain a sampling result;
calculating the distance between the reflector corresponding to the pulse sequence and the light detection device based on the sampling result to obtain a point cloud, each point in the point cloud including distance information between the light detection device and one reflector;
mapping the point cloud within a certain period of time into a frame of image; and
performing noise filtering on the image based on the filtering strategy.

9. The method of claim 8, wherein determining the working mode for performing the light detection based on the obtained environment parameter includes:
determining the mode for light detection is the special weather working mode based on the obtained environment parameter, in the special weather working mode, the light detection including filtering the points belonging to the particle objects in the special weather in the image based on the filtering strategy.

10. The method of claim 9, wherein:
the filtering strategy includes a third filtering strategy, and the third filtering strategy indicates:
a distance indicated by the distance information included in the point to be filtered is within a second distance threshold, and
a difference between the distance indicated by the distance information included in the point to be filtered and a distance indicated by distance information included an adjacent point is less than or equal to a third distance threshold.

11. A light detection device comprising:
an acquisition module configured to acquire an environment parameter for performing light detection;
a determination module configured to determine a working mode for performing light detection based on the environment parameter acquired by the acquisition module, wherein different working modes correspond to different working parameters; and
a light detection module configured to perform light detection based on the working mode determined by the determination module, wherein the light detection is configured to calculate a distance between the light detection and a reflector based on a transmitted pulse sequence and a reflected pulse sequence reflected by the reflector.

12. The device of claim 11, wherein the different working parameters corresponding to the different working modes include at least one of:
a power of the transmitted pulse sequence, a frequency of the transmitted pulse sequence, a scanning range or a scanning pattern of the transmitted pulse sequence, a magnification of an electrical signal converted from the reflected pulse sequence, a sampling frequency for sampling the electrical signal converted from the reflected pulse sequence, a minimal sampling threshold for sampling the electrical signal converted from the reflected pulse sequence, and a filtering strategy, the filtering strategy being configured to filter a processing result corresponding to the reflected pulse sequence.

13. The device of claim 11, wherein the determination module is further configured to:
determine that a mode for performing the light detection is a special weather working mode based on the obtained environment parameter,
in the special weather working mode, the light detection including:
converting the reflected pulse sequence into the electrical signal; and
determining whether to filter the electrical signal based on the filtering strategy and filtering the electrical signal that needs to be filtered, the reflector corresponding to the electrical signal that needs to be filtered being a particle object in a special weather, and the reflector corresponding to the electrical signal that does not need to be filtered being a normal object.

14. The device of claim 13, wherein:
the filtering strategy includes a first filtering strategy, and the first filtering strategy indicates: when the distance between the reflector corresponding to the electrical signal and the light detection device is within a first distance threshold, and a peak value of the electrical signal is less than a first peak threshold, determining that the electrical signal needs to be filtered.

15. The device of claim 14, wherein:
the special weather working mode includes at least two special weather working modes, the at least two special weather working modes including special weather working modes corresponding to different weather types, or including different degrees of special weather working modes of a same weather type, the first distance threshold and/or the first peak threshold being different in different special weather working modes.

16. The device of claim 13, wherein:
the filtering strategy includes a second filtering strategy, the second filtering strategy indicating using a filtering model to determine whether to filter the electrical signal or a probability of filtering; and
the filtering model includes parameter characteristics of the electrical signal when the reflector is the normal object and/or the parameter characteristics of the electrical signal when the reflector is the particle object in the special weather.

17. The device of claim 16 further comprising:
a training module configured to use machine learning methods to perform cluster analysis on the electrical signal corresponding to the normal object and the electrical signal corresponding to the particle object in the special weather; and
online training the filtering model.

18. The device of claim 11, wherein the light detection includes:
sampling the electrical signal converted from the reflected pulse sequence to obtain a sampling result;
calculating the distance between the reflector corresponding to the pulse sequence and the light detection device based on the sampling result to obtain a point cloud, each point in the point cloud including distance information between the light detection device and one reflector;
mapping the point cloud within a certain period of time into a frame of image; and
performing noise filtering on the image based on the filtering strategy.

[symbol]

19. The device of claim 18, wherein the determination module is further configured to:
determine the mode for light detection is the special weather working mode based on the obtained environment parameter, in the special weather working mode, the light detection including filtering the points belonging to the particle objects in the special weather in the image based on the filtering strategy.

20. The device of claim 19, wherein:
the filtering strategy includes a third filtering strategy, and the third filtering strategy indicates:
a distance indicated by the distance information included in the point to be filtered is within a second distance threshold, and
a difference between the distance indicated by the distance information included in the point to be filtered and a distance indicated by distance information included an adjacent point is less than or equal to a third distance threshold.
